(19) United States
(12) Patent Application Publication
(10) Pub. No.: US 2025/0148682 A1
(43) Pub. Date: May 8, 2025

(54) METHOD AND SYSTEM FOR GENERATING HUMAN ANIMATION FROM SMPL SERIES PARAMETERS

(71) Applicant: Korea Electronics Technology Institute, Seongnam-si (KR)

(72) Inventors: Choong Il KIM, Seoul (KR); Sa Im SHIN, Seoul (KR); Jin Yea JANG, Seongnam-si (KR); San KIM, Seongnam-si (KR); Byung Gill JOE, Seongnam-si (KR)

(73) Assignee: Korea Electronics Technology Institute, Seongnam-si (KR)

(21) Appl. No.: 18/938,478

(22) Filed: Nov. 6, 2024

(30) Foreign Application Priority Data
Nov. 8, 2023 (KR) 10-2023-0153364

(51) Int. Cl. G06T 13/40; G06T 7/20

(52) U.S. Cl. CPC G06T 13/40; G06T 7/20

(57) ABSTRACT

Provided are a method and a system for generating a human animation from SMPL series parameters. An animation generation method according to an embodiment includes: extracting, by a motion extraction module, motion information from an image content; converting, by a motion conversion module, the extracted motion information into parameters required by an animation generation module; and generating, by the animation generation module, a motion image of a human object from the converted motion information. Accordingly, an animation accurately showing motions of an object appearing in an image content by a more realistic 3D model may be generated and digital human contents of high reality may be created and used.

### CROSS-REFERENCE TO RELATED APPLICATION(S) AND CLAIM OF PRIORITY

This application is based on and claims priority under 35 U.S.C. § 119 to Korean Patent Application No. 10-2023-0153364, filed on Nov. 8, 2023, in the Korean Intellectual Property Office, the disclosure of which is herein incorporated by reference in its entirety.

### BACKGROUND

### Field

The disclosure relates to a human animation generation technology, and more particularly, to a method for generating a 3D human animation from a motion of an object appearing in an image content (image or video) based on artificial intelligence (AI) and a commonly used tool.

### Description of Related Art

As a technology that extracts a motion of an object from a current image and generates an animation by using a 3D model, there is a method for rendering by using a model of skinned multi-person linear (SMPL) series. However, rendering by the SMPL model does not provide reality to make an object be seen as a human, and thus, is not enough to be used for metaverse or digital humans.

The “MetaHuman Creator” which is a commonly used digital human generation framework may provide avatars of high quality and provide high reality. This framework uses a toolset which is called the “Unreal Engine” to extract 3D rotation coordinates from an image.

However, this toolset has problems that it does not recognize a plurality of persons and the accuracy of extraction of motion features is significantly degraded when a portrait image is provided at a single viewpoint.

### SUMMARY

The disclosure has been developed in order to solve the above-described problems, and an object of the disclosure is to provide, as a solution for creating and using a digital huma content of high reality, a method for generating an animation showing a motion of an object appearing in an image through a more realistic 3D model by using SMPL series parameters and a toolset of a commonly used framework, such as the Unreal Engine of the MetaHuman Creator.

To achieve the above-described object, an animation generation method according to an embodiment of the disclosure may include: extracting, by a motion extraction module, motion information from an image content; converting, by a motion conversion module, the extracted motion information into parameters required by an animation generation module; and generating, by the animation generation module, a motion image of a human object from the converted motion information.

The motion information may be a SMPL series parameter. The SMPL series parameter may be one of a SMPL parameter, a SMPL+H parameter, and a SMPLX parameter.

Converting may include: a first conversion step of converting a format of a pose parameter among the SMPL series parameters; and a second conversion step of converting a unit of a shape parameter among the SMPL series parameters.

The first conversion step may include converting the pose parameter into a Euler-angle. The second conversion step may include converting the shape parameter into a unit of centimeter (cm).

The motion extraction module may be a machine learning model that is trained to extract motion information from an inputted image content. The image content may be an image which is a still image or a video which is a moving image. The animation generation module may be a toolset of a commonly used framework.

According to another aspect of the disclosure, there is provided an animation generation system including: a motion extraction module configured to extract motion information from an image content; a motion conversion module configured to convert the extracted motion information into parameters required by an animation generation module; and the animation generation module configured to generate a motion image of a human object from the converted motion information.

According to still another aspect of the disclosure, there is provided a motion information generation method including: extracting, by a motion extraction module, motion information from an image content; and converting, by a motion conversion module, the extracted motion information into parameters required by an animation generation module, wherein the converted motion information is inputted to the animation generation module and is used for generating a human animation comprising a motion image of a human object.

As described above, according to embodiments of the disclosure, SMPL series parameters extracted from an image content may be converted into a format that is required by a toolset of a commonly used framework, such as the Unreal Engine of the MetaHuman Creator, and may be inputted, so that an animation accurately showing motions of an object appearing in the image content by a more realistic 3D model may be generated and digital human contents of high reality may be created and used.

According to embodiments of the disclosure, various motion extraction modules may be combined so that a 3D modeling animation may be generated in real time or from an image in which a plurality of objects appear

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a configuration of a human animation generation system according to an embodiment of the disclosure; and

FIG. 2 is a flowchart illustrating a human animation generation method according to another embodiment of the disclosure.

### DETAILED DESCRIPTION

Hereinafter, the disclosure will be described in more detail with reference to the accompanying drawings.

Embodiments of the disclosure provide a method and a system for generating a human animation from SMPL series parameters. The disclosure relates to a technology that uses SMPL series parameters extracted from an image content in generating a more realistic human animation with a toolset of a commonly used framework, such as the Unreal Engine of the MetaHuman Creator, and enhances the object extraction accuracy of the corresponding toolset.

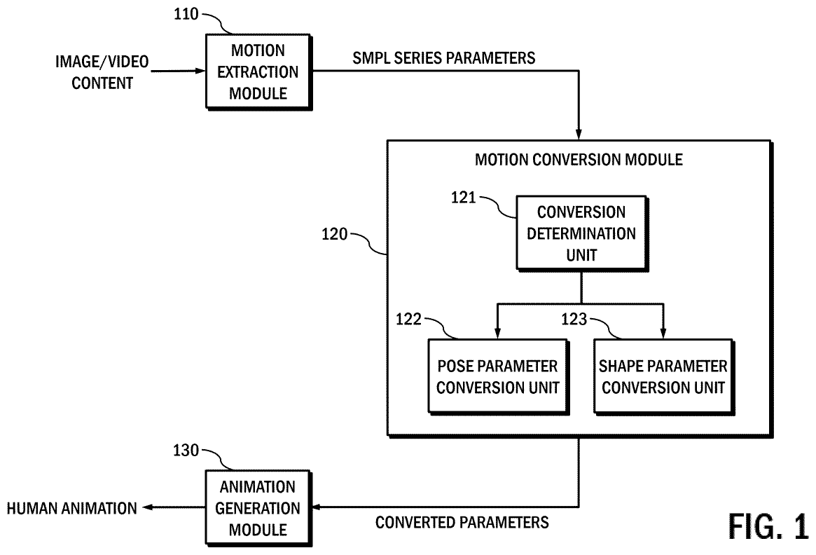

FIG. 1 is a view illustrating a configuration of a human animation generation system according to an embodiment of the disclosure. The human animation generation system according to an embodiment of the disclosure may extract SMPL series parameters from an image content and then convert the SMPL series parameters, and may use the converted SMPL series parameters for generating a human animation.

The human animation generation system according to an embodiment of the disclosure, which performs the above-described function, may include a motion extraction module 110, a motion conversion module 120, and an animation generation module 130.

The motion extraction module 110 may receive an image content and may extract motion information. The image content may include an image which is a still image and a video which is a moving image. The extracted motion information may be a SMPL series parameter, and may be one of a SMPL parameter, a SMPL+H parameter, an SMPLX parameter.

The SMPL parameter may include a shape parameter and a pose parameter. The shape parameter is a shape vector which is comprised of 10 real values (PCA coefficients), and each real value may be interpreted as an amount of expansion/shrink of a human body object along a specific axis direction such as a height axis (tall/short). The pose parameter is a pose vector which is comprised of 24×3 real values, and keeps the relative rotation corresponding to joint parameters. Each rotation is encoded as an arbitrary 3D vector in axis-angle rotation representation.

The SMPL+H is comprised of hand parameters added to the SMPL parameters. The hand parameter is a pose vector which is 2×15×3 dimensions and is comprised of 15 real values corresponding to joints of each of the left hand, the right hand. The pose parameter keeps the relative rotation corresponding to joint parameters. Each rotation is encoded as an arbitrary 3D vector in axis-angle rotation representation.

The SMPLX is comprised of hand parameters and face parameters added to the SMPL parameters. The face parameter is defined as a jaw parameter and an expression parameter. The jaw parameter indicates 3D relative rotation coordinates of jaw. The expression parameter is a shape vector which is comprised of 10 real values (PCA coefficients), and each real value may be interpreted as a facial expression along a specific axis direction, such as smiling or crying.

Each of the SMPL series parameters may have a camera translation parameter for determining the position of a camera.

The motion extraction module 110 may be implemented by a machine learning model that is trained to extract SMPL series parameters corresponding to an inputted image content, and there is no limit to types and structures and learning method of the machine learning model.

The motion conversion module 120 converts the SMPL series parameters outputted from the motion extraction module 110 into parameters that are required to be inputted to the animation generation module 130. The motion conversion module 120 for performing the above-described function may include a conversion determination unit 121, a pose parameter conversion unit 122, and a shape parameter conversion unit 123.

The conversion determination unit 121 transmits the pose parameter among the SMPL series parameters inputted from the motion extraction module 110 to the pose parameter conversion unit 122, and transmits the shape parameter to the shape parameter conversion unit 123. The conversion determination unit 121 does not transmit the parameter that is not required to be converted to the parameter conversion unit 122, 123.

The pose parameter conversion unit 122 is configured to convert the format of the pose parameter, and specifically, converts the pose parameter into a Euler-angle. A joint rotation angle which is the pose parameter converted into the Euler angle may be outputted as a plurality of values due to coordinate system characteristics, and the pose parameter conversion unit 122 may convert the format of the pose parameter into a value which is optimal for the animation generation module 130.

The shape parameter conversion unit 123 is configured to convert the unit of the shape parameter, and specifically, converts the unit of the shape parameter into a unit, centimeter, required by the animation generation module 130.

The animation generation module 130 generates a motion image showing human's body, the pose of hand, a facial expression from the motion information converted by the motion conversion module 120, and outputs a human animation.

The animation generation module 130 may be implemented by using the Unreal Engine of the MetaHuman Creator described above, and does not preclude implementation by toolsets of other commonly used frameworks.

When the image content inputted to the motion extraction module 110 is an image, the animation generation module 130 may generate a human object having a static pose as one frame. On the other hand, when the image content inputted to the motion extraction module 110 is a video, the animation generation module 130 may generate a human object having dynamic motions as a plurality of frames.

Furthermore, when the image content inputted to the motion extraction module 110 includes a single human object, the animation generation module 130 may output an animation on the single human object. On the other hand, when the image content inputted to the motion extraction module 110 includes a plurality of human objects, the animation generation module 130 may output an animation on the plurality of human objects.

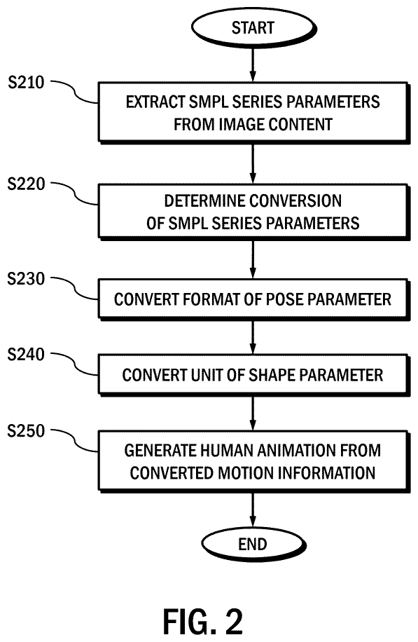

FIG. 2 is a flowchart illustrating a human animation generation method according to another embodiment of the disclosure.

To generate a human animation, the motion extraction module 110 receives an image content and extracts SMPL series parameters as motion information (S210).

The conversion determination unit 121 of the motion conversion module 120 transmits a pose parameter among the SMPL series parameters outputted at step S210 to the pose parameter conversion unit 122, and transmits a shape parameter to the shape parameter conversion unit 123 (S220).

The pose parameter conversion unit 122 converts the format of the pose parameter into a Euler-angle (S230), and the shape parameter conversion unit 123 converts the unit of the shape parameter into a unit, centimeter, required by the animation generation module 130 (S240).

The animation generation module 130 generates a human animation comprised of motion images of the human object from the motion information converted at steps S230 and S240.

Up to now, the method and the system for generating a human animation from SMPL series parameters have been described in detail with reference to preferred embodiments.

Embodiments of the disclosure propose a technology that converts SMPL series parameters extracted by a machine learning model through logics and equations without a complex model, and is applied to a commonly used framework such as the MetaHuman Creator.

Accordingly, by generating an amination on object's motions from an image content by using a more realistic 3D model, digital human contents of high reality may be created and used, and various motion extraction modules may be combined so that high compatibility may be provided.

The technical idea of the disclosure is applicable when a motion information generation system which includes the motion extraction module 110 and the motion conversion module 120 except for the animation generation module 130 in the human animation generation system of FIG. 1 is implemented.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An animation generation method comprising:
extracting, by a motion extraction module, motion information from an image content;
converting, by a motion conversion module, the extracted motion information into parameters required by an animation generation module; and
generating, by the animation generation module, a motion image of a human object from the converted motion information.

2. The animation generation method of claim 1, wherein the motion information is a SMPL series parameter.

3. The animation generation method of claim 2, wherein the SMPL series parameter is one of a SMPL parameter, a SMPL+H parameter, and a SMPLX parameter.

4. The animation generation method of claim 2, wherein converting comprises:
a first conversion step of converting a format of a pose parameter among the SMPL series parameters; and
a second conversion step of converting a unit of a shape parameter among the SMPL series parameters.

5. The animation generation method of claim 4, wherein the first conversion step comprises converting the pose parameter into a Euler-angle.

6. The animation generation method of claim 4, wherein the second conversion step comprises converting the shape parameter into a unit of centimeter (cm).

7. The animation generation method of claim 1, wherein the motion extraction module is a machine learning model that is trained to extract motion information from an inputted image content.

8. The animation generation method of claim 1, wherein the image content is an image which is a still image or a video which is a moving image.

9. The animation generation method of claim 1, wherein the animation generation module is a toolset of a commonly used framework.

10. An animation generation system comprising:
a motion extraction module configured to extract motion information from an image content;
a motion conversion module configured to convert the extracted motion information into parameters required by an animation generation module; and
the animation generation module configured to generate a motion image of a human object from the converted motion information.

11. A motion information generation method comprising:
extracting, by a motion extraction module, motion information from an image content; and
converting, by a motion conversion module, the extracted motion information into parameters required by an animation generation module,
wherein the converted motion information is inputted to the animation generation module and is used for generating a human animation comprising a motion image of a human object.
